(19) United States
(12) Patent Application Publication
(10) Pub. No.: US 2012/0211687 A1
(43) Pub. Date: Aug. 23, 2012

(54) ISOLATION VALVE WITH MOTOR DRIVEN SEALING MECHANISM

(76) Inventors: Robert P. Benjey, DEXTER, MI (US); MATTHEW L. ERDMANN, YPSILANTI, MI (US)

(21) Appl. No.: 13/029,210

(22) Filed: Feb. 17, 2011

(51) Int. Cl. F16K 31/44

(52) U.S. Cl. 251/248

(57) ABSTRACT

An isolation valve has a housing having a vent path and a sealing member that opens and closes the vent path. The sealing member is driven by a motor via a gear arrangement that links the sealing member with the motor. The motor drives the gear arrangement in a first direction to open the vent path and a second direction to close the vent path. During operation, a motor current rises when the sealing member reaches the first position and/or the second position. The controller detects the motor current rise and changes operation of the motor (e.g., stops the motor) in response.

### TECHNICAL FIELD

The present invention relates to a valve assembly for controlling fluid flow to and from a high-pressure fuel tank, and more particularly to such a valve assembly having a motor-driven seal.

### BACKGROUND OF THE INVENTION

High-pressure fluid reservoirs, such as high-pressure fuel tanks, may use an isolation valve to open and close a vapor path between the fuel tank and a purge canister. In a typical evaporative emissions system, vented vapors from the fuel system are sent to a purge canister containing activated charcoal, which adsorbs fuel vapors. During certain engine operational modes, with the help of specifically designed control valves, the fuel vapors are adsorbed within the canister. Subsequently, during other engine operational modes, and with the help of additional control valves, fresh air is drawn through the canister, pulling the fuel vapor into the engine where it is burned.

For high-pressure fuel tank systems, an isolation valve may be used to isolate fuel tank emissions and prevent them from overloading the canister and vapor lines. In some systems, it may be desirable to isolate the fuel tank except during refueling or during extreme pressure conditions to avoid the potential risk of damage to the system. Due to the high-pressure environments in which isolation valves often operate, the sealing mechanisms in the isolation valve should operate consistently.

There is a desire for a system that ensures consistent seal operation while keeping the overall isolation valve structure simple.

### SUMMARY OF THE INVENTION

An isolation valve according to one embodiment of the invention comprises a housing having a vent path and a sealing member aligned with the vent path and movable between a first position to open the vent path and a second position to close the vent path. The sealing member is driven by a motor that is controllable by a controller, and a gear arrangement couples the motor with the sealing member. The motor drives the gear arrangement in a first direction to open the vent path and a second direction to close the vent path. During operation, a motor current rises when the sealing member reaches one of the first position and the second position, and the controller detects the motor current rise and changes operation of the motor in response.

### BRIEF DESCRIPTION OF THE DRAWINGS

FIG. 1 is a schematic diagram of an isolation valve according to one embodiment of the invention where a seal is in an open position;

FIG. 2 is a schematic diagram of the isolation valve in FIG. 1 where the seal is in a closed position; and

FIG. 3 is a schematic diagram of an isolation valve according to another embodiment of the invention.

### DETAILED DESCRIPTION OF THE INVENTION

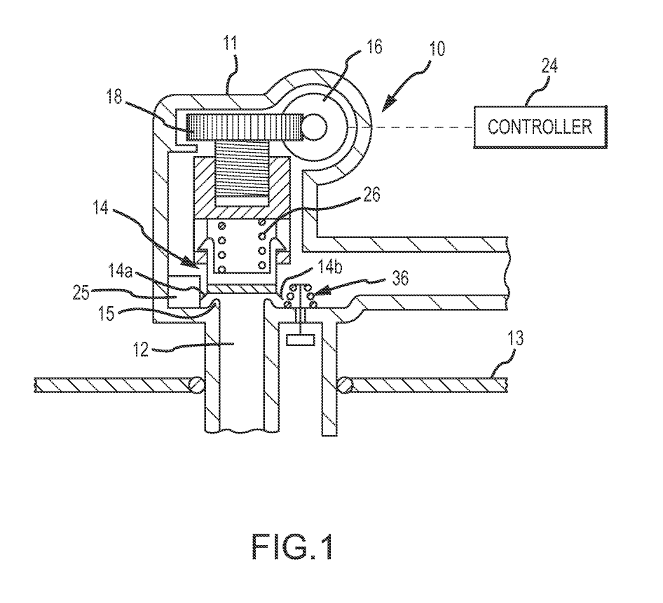

FIG. 1 is a representative diagram of an isolation valve 10 according to one embodiment of the invention. In this example, the isolation valve 10 has a housing 11 and is arranged as an inline valve disposed in a vent path 12 formed in the housing 11 and opening into a fuel tank 13. However, the isolation valve 10 can be disposed in a high-pressure fluid system in any way without departing from the scope of the invention. For example, the housing 11 can be configured to be mounted on or in the fuel tank 13.

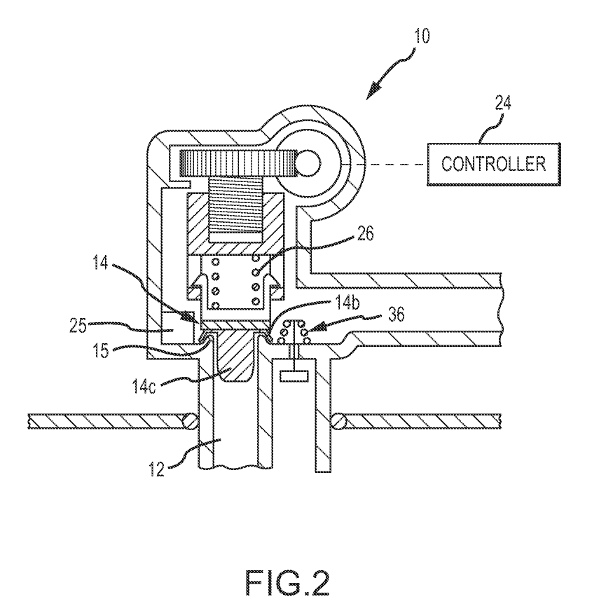

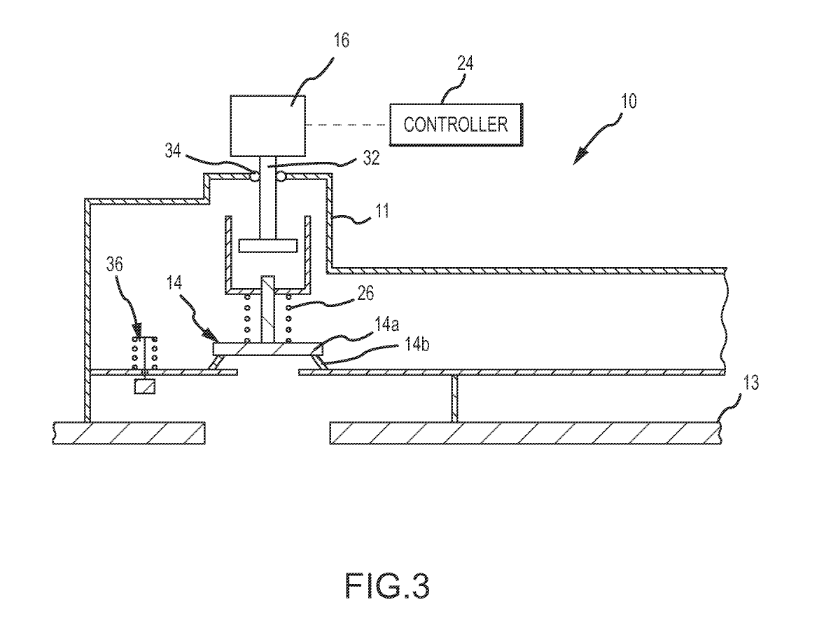

In one embodiment, the isolation valve 10 may have a sealing member 14 disposed in the vent path 12 and aligned with a seat 15. The sealing member 14 itself may have any appropriate structure that provides secure sealing in the isolation valve 10. FIGS. 1 and 3 show a sealing member 14 having a seal plate 14a and a gasket 14b to prevent leakage, while FIG. 2 shows a sealing member 14 having a tapered stopper 14c with the gasket 14b to ensure good alignment between the sealing member 14 and the seat 15. Those of ordinary skill in the art will recognize other possible sealing member 14 structures that may be used without departing from the scope of the invention.

The sealing member 14 may be driven by an electric motor 16 that actuates a gear arrangement 18. The gear arrangement 18 may be any appropriate gear system, such as planetary gears, worm drives, or other systems. The example shown in FIG. 1 uses a worm drive, but those of ordinary skill in the art will understand that the gear arrangement 18 can have any configuration without departing from the scope of the invention. The sealing member 14, seat 15, motor 16, and gear arrangement 18 are operatively coupled to open and close the vent path 12.

Operation of the isolation valve 10, and more particularly operation of the motor 16, may be controlled by a vehicle controller 24. The controller 24 sends signals to the motor 16 to start and stop of the motor 16 as well as control its direction of operation based on various inputs such as, for example, a sensed tank pressure. Possible motor 16 operation modes will be described in more detail below.

The operation of the isolation valve 10 will now be described with respect to FIGS. 1 and 2. To close the valve 10, the controller 24 sends a signal to the valve 10 to start operation of the motor 16. The motor 16 in turn operates the gear arrangement 18, in turn lowers the sealing member 14 until the sealing member 14 contacts the seat 15. In one embodiment, there is a hard stop 25 that limits the downward travel of the sealing member 14. When the hard stop 25 is reached, the motor 16 stalls and the current through the motor 16 will spike, and this spike is detected by the controller 24. The controller 24 then stops supplying current to the motor 16, stopping the downward movement of the sealing member 14. At this point, the sealing member 14 closes the vent path 12. The location of the hard stop 25 dictates the location at which the sealing member 14 stop, which in turn affects the load applied by the sealing member 14 onto the seat 15. If a lost motion member 26 is used as described in more detail below, the location of the hard stop 25 also controls the amount of spring force applied by the lost motion member 26 onto the sealing member 14 when it closes the vent path 12.

To open the vent path, the isolation valve 10 works the same way as described above but in reverse. More particularly, the controller 24 sends a signal to the motor 16 to open the valve 10, causing the motor 16 to turn the gear arrangement 18 in the opposite direction and lift the sealing member 14 off the seat 15. Note that a hard stop may be included to stop the motor 16 in this direction as well, but since the sealing member 14 operation does not necessarily need to be as precise in this direction, the motor 16 may be stopped in this direction simply when the moving parts in the motor 16 bottom out (e.g., when they are completely threaded together).

Although the sealing member 14 provides a secure seal, it may be desirable to provide additional structures in the isolation valve 10 to ensure consistent sealing despite variations and changes in the motor 16 and/or the gear arrangement 18 due to, for example, wear, design, assembly, or manufacturing. Thus, the isolation valve 10 may also include the lost motion member 26, such as a spring, that applies a downward biasing force to the sealing member 14 to bias the sealing member 14 toward the seat 15. This biasing force helps the isolation valve 10 become less sensitive to positional and force variations in the motor 16 and gear arrangement 18, ensuring consistent sealing action despite these variations.

In one embodiment, the biasing force in the lost motion member 26 allows the isolation valve 10 to be used as an overpressure relief device. More particularly, the lost motion member 26 applies a spring force when the motor 16 bottoms out due to the hard stop 25 and stops operation. As noted above, this spring force, combined with the location of the sealing member 14 when in the closed position, controls the amount of load on the seat 15 when the isolation valve 10 is closed.

The lost motion member 26 also allows the isolation valve 10 to act as a bleed valve by gradually allowing pressure to escape before opening completely. For example, to bleed pressure through the isolation valve 10, the motor 16 and gear arrangement 18 may turn only slightly to lift the sealing member 14 slightly of the seat 15. However, the biasing force from the lost motion member 26 tends to bias the sealing member 14 downward toward the seat 15. As a result, the high vapor pressure in the vent path 12 may counteract the biasing force of the lost motion member 26 and allow vapor to escape, but the small space between the sealing member 14 and the seat 15 prevents vapors from rushing through the vent path 12 at full force. Thus, vapor can bleed in a controlled manner through the vent path 12, gradually reducing the vapor pressure until, for example, the pressure level drops to a level where the valve 10 can be opened completely in a controlled manner without adverse effects elsewhere in the emissions system. This gradual bleeding can be controlled even further by incorporating the stopper 14c since the small gap between the stopper 14c and the walls forming the vent path 12 chokes vapor flow.

In other words, the combination of the motor 16 and the biasing force of the lost motion member 26 allows close control over the amount of pressure relief provided by the isolation valve 10. The specific degree of pressure relief may be fine-tuned by selecting the biasing force of the lost motion member 26 so that it has a predetermined degree of compression at a given motor 16 position. For example, the biasing force may be selected to provide a desired amount of pressure relief during an overpressure condition.

FIG. 3 illustrates the isolation valve 10 according to another embodiment of the invention. In this embodiment, the isolation valve 10 may be disposed outside the fuel tank 13, and the motor 16 itself is disposed outside the housing 11 of the isolation valve 10. In this embodiment, a shaft 32 extends through the housing 11 to couple the motor 16 with the sealing member 14. A shaft seal 34 may be used to prevent leakage through the housing 11. The other components of the isolation valve 10 operate in the same manner as the embodiments described above.

If the isolation valve 10 is used in an environment where vacuum pressures are a potential issue, a vacuum relief valve 36 may be incorporated into the emissions system or even within the isolation valve 10 itself.

Because the operation of the isolation valve 10 is controlled by the controller 24, its operation does not depend on responding to changes in tank pressure. Thus, the isolation valve 10 may also be used as a fuel limit valve. For example, a fuel level sensor (not shown) may be used to monitor a fuel level in a tank and send a signal to the controller 24 when the tank is full. The controller 24 then sends a signal to the isolation valve 10 to close, thereby allowing pressure to build up in the tank and induce shutoff in a refilling nozzle.

While the best modes for carrying out the invention have been described in detail, those familiar with the art to which this invention relates will recognize various alternative designs and embodiments for practicing the invention within the scope of the appended claims.

What is claimed is:

1. An isolation valve, comprising:
a housing having a vent path;
a sealing member aligned with the vent path, wherein the sealing member is movable between a first position to open the vent path and a second position to close the vent path;
a motor controllable by a controller; and
a gear arrangement coupling the motor with the sealing member, wherein the motor drives the gear arrangement in a first direction to open the vent path and a second direction to close the vent path,
wherein a motor current rises when the sealing member reaches one of the first position and the second position, and wherein the controller detects the motor current rise and changes operation of the motor in response.

2. The isolation valve of claim 1, wherein the sealing member comprises:
a seal plate; and
a gasket disposed on the seal plate.

3. The isolation valve of claim 1, wherein the sealing member comprises a tapered stopper that is insertable into the vent path.

4. The isolation valve of claim 1, further comprising a hard stop disposed in the housing to limit travel of the sealing member when it reaches one of the first position and the second position.

5. The isolation valve of claim 4, wherein the hard stop is associated with the second position.

6. The isolation valve of claim 1, further comprising a resilient member that biases the sealing member toward the second position.

7. The isolation valve of claim 7, wherein the resilient member has a biasing force that provides a desired amount of pressure relief during an overpressure condition.

8. The isolation valve of claim 1, further comprising a vacuum relief valve disposed in the housing.

9. An emissions system for vapor control in a high-pressure fuel tank, comprising:
a controller; and
an isolation valve having
a housing having a vent path;
a sealing member aligned with the vent path, wherein the sealing member is movable between a first position to open the vent path and a second position to close the vent path;
a motor controllable by the controller; and
a gear arrangement coupling the motor with the sealing member, wherein the motor drives the gear arrangement in a first direction to open the vent path and a second direction to close the vent path,
wherein a motor current rises when the sealing member reaches one of the first position and the second position, and wherein the controller detects the motor current rise and changes operation of the motor in response

10. The emissions system of claim 9, wherein the sealing member comprises:
a seal plate; and
a gasket disposed on the seal plate.

11. The emissions system of claim 9, further comprising a hard stop disposed in the housing to limit travel of the sealing member when it reaches one of the first position and the second position.

12. The emissions system of claim 9, wherein the hard stop is associated with the second position.

13. The emissions system of claim 9, further comprising a resilient member that biases the sealing member toward the second position.

14. The emissions system of claim 13, wherein the resilient member has a biasing force that provides a desired amount of pressure relief during an overpressure condition.

15. The emissions system of claim 9, further comprising a vacuum relief valve.

16. The emissions system of claim 9, wherein the controller receives a signal from a fuel level sensor and sends a signal to the isolation valve to close when the fuel level sensor indicates a predetermined fuel level.
